(19) United States
(12) Patent Application Publication
(10) Pub. No.: US 2017/0085136 A1
(43) Pub. Date: Mar. 23, 2017

(54) MONITORING AN APPARATUS FOR INDUCTIVE ENERGY TRANSMISSION - APPARATUS AND METHOD

(71) Applicant: Robert Bosch GmbH, Stuttgart (DE)

(72) Inventors: Pascal Pfeiffer, Kerpen (DE); Tobias Zibold, Stuttgart (DE); Joerg Mecks, Beilstein (DE); Markus Mayer, Heilbronn (DE); Gerald Heinrich Oettle, Esslingen (DE)

(21) Appl. No.: 15/126,611

(22) PCT Filed: Dec. 18, 2014
(86) PCT No.: PCT/EP2014/078423

§ 371 Date: Sep. 16, 2016

(30) Foreign Application Priority Data
Mar. 26, 2014 (DE) 102014205598.9

(51) Int. Cl. H02J 50/60; H02J 50/40; G01V 3/10; H02J 50/12

(52) U.S. Cl. CPC H02J 50/60; H02J 50/12; H02J 50/40; G01V 3/10

(57) ABSTRACT

The invention relates to a monitoring apparatus (10) for at least one electrical apparatus designed for inductive energy transmission, having a sensor device (12) with a coil arrangement comprising at least one coil (14) and an evaluation device (20) for detecting whether at least one measured physical variable differs from at least one predefined normal range of values, wherein the at least one coil (14) of the coil arrangement is wound, designed and/or attached to at least one filter in such a manner that currents and/or voltages induced in the at least one coil (14) of the coil arrangement can be at least partially averaged and/or filtered out. The invention also relates to electrical apparatuses equipped with the monitoring apparatus (10) and to corresponding methods.

### BACKGROUND OF THE INVENTION

The invention relates to a monitoring apparatus for at least one electrical apparatus designed for inductive energy transmission. The invention likewise relates to an electrical apparatus designed for inductive energy transmission to a further electrical apparatus. In addition, the invention relates to a method for monitoring at least one partial surrounding area of at least one electrical apparatus designed for inductive energy transmission and to a method for inductive energy transmission between two electrical apparatuses.

An apparatus for inductive transmission of electrical energy is described in the German patent publication DE 20 2009 009 693 U1. The apparatus for transmission of electrical energy comprises a charging station having a primary coil. An induction current in a secondary coil of charging electronics for charging a battery of a vehicle is thereby to be generated by passing a current through the primary coil. A plurality of measuring coils is disposed in a housing of the primary coil, said measuring coils being connected in each case to an impedance measuring apparatus. The impedance measuring apparatuses are connected to a central evaluation device. If an energy transmission does not occur between the primary coil and the secondary coil, a measuring current of predetermined strength is applied to the measuring coils. An undesired metallic foreign body in the vicinity of the charging station can be detected based on the different impedance changes of the measuring coils.

### SUMMARY OF THE INVENTION

The present invention creates options for monitoring at least one partial surrounding area of an electrical apparatus designed for inductive energy transmission, which options can still reliably carry out the desired functions thereof even when magnetic fields (generated for energy transmission) are present in the at least one coil of the coil arrangement. At the same time, a detection of foreign objects having a high sensitivity and a comparatively low error rate (of approximately zero) is ensured in all of the options for monitoring the electrical apparatus designed for inductive energy transmission that are implemented by means of the present invention. The present invention therefore contributes advantageously to safeguarding inductive energy transmissions between two electrical apparatuses.

The present invention also particularly facilitates a detection of foreign objects during an inductive energy transmission carried out without interruption. For example, it is therefore possible to charge a battery via the inductive energy transmission without a significant loss of efficiency. Because the conventional problem of the detection of foreign objects being affected by the alternating magnetic fields generated for the inductive energy transmission is eliminated, an interruption of the inductive energy transmission in order to examine at least the energy transmission path for a possibly present foreign object is prevented. In addition, a desired inductive energy transmission can be started immediately by means of the present invention without the energy transmission path to first be scanned for a possibly present foreign object. Instead, the monitoring of the energy transmission path can also be begun simultaneously with starting the inductive energy transmission.

The subject matters of the present invention particularly make it possible to determine an undesired presence of at least one foreign object which is at least in part formed from a conductive material. Thus, foreign objects consisting of critical materials, which can be quickly heated up or damaged during an inductive energy transmission, can specifically be detected in the proximity of the at least one electrical apparatus for inductive energy transmission.

The subject matters of the present invention can also be modified for an autonomous calibration. When, in fact, only one electrical apparatus is present at the desired location of the inductive energy transmission, the foreign object detection can furthermore be carried out between the electrical apparatus and a further electrical apparatus. It is therefore not necessary to dispose the two electrical apparatuses in close proximity to one another before the detection of foreign objects can be started.

The detection of foreign objects that can be carried out by means of the present invention is also very robust. Not only is an influence of external magnetic interference fields noncritical, but also ambient conditions, such as, for example, the weather, a falling of leaves, a snowfall and/or pollutants, can neither impair the sensitivity nor the low error rate of the foreign object detection.

In one advantageous embodiment of the monitoring apparatus, the at least one electronic circuit comprises at least one resonant circuit which can be set into resonance and in which the at least one coil of the coil arrangement is integrated. For example, the at least one physical variable can be determined with respect to a temporal change of at least one resonance frequency of the at least one resonant circuit, a temporal change of the at least one resonance amplitude of the at least one resonant circuit and/or a temporal change of at least one temporally averaged amplitude of the at least one resonant circuit by means of the evaluation device. At least one derivative of the at least one resonance frequency, the at least one resonance amplitude and/or the at least one temporally averaged amplitude can particularly be determined as the at least one current actual variable.

The values described here can be easily determined and can be evaluated with respect to a possible deviation from the at least one predefined normal range of values by means of cost effective electronics that require little installation space. The monitoring apparatus is thus simple to manufacture, cost effective and can be easily disposed or integrated in a desired position.

In a further advantageous embodiment, the at least one coil of the coil arrangement is integrated into at least one CCFL inverter circuit as the at least one resonant circuit. The advantages of such a circuit, which is also frequently referred to as a Royer converter or as a Royer circuit, can thus also be used for the monitoring apparatus according to the invention.

In another advantageous embodiment, the monitoring apparatus comprises at least one receiver coil as the at least one coil integrated into the at least one electronic circuit and additionally at least one transmitter coil, wherein the at least one transmitter coil can be operated by the sensor apparatus such that at least one electromagnetic signal can be transmitted by means of the at least one transmitter coil, and, during the transmission of the at least one electromagnetic signal, a voltage induced in the at least one receiver coil and/or an amperage generated in the at least one receiver coil can be ascertained by means of the at least one electronic circuit as the at least one physical variable.

The at least one receiver coil can particularly be disposed in a partially overlapping manner with respect to the at least one transmitter coil such that, when the surrounding area of the at least one receiver coil and the at least one transmitter coil is free of foreign objects, the voltage and/or amperage induced in the at least one receiver coil during the transmission of the at least one electromagnetic signal disappears.

For example, when the electrical apparatus and/or the further electrical apparatus are located in the foreign object protection mode, an inductive energy transmission between the electrical apparatus and the further electrical apparatus cannot be started, is prevented from starting at least for the predefined period of time, is concluded or can be carried out for the predefined period of time only with a reduced energy transmission rate with respect to a normal mode of the electrical apparatus and/or the further electrical apparatus. In this way, the at least one foreign object is neither undesirably heated up nor is damage to the same to be feared. In addition to the foreign object protection described here, an improved protection of the monitoring apparatus and the electrical apparatuses from damage by the heated foreign object and an improved protection of individuals in the vicinity are ensured.

In a cost effective embodiment, the coil arrangement can comprise a plurality of coils having different winding directions. As an alternative or in addition thereto, the coil arrangement can also comprise at least one bifilar coil, at least one figure-of-eight shaped coil, at least one butterfly coil and/or at least one binocular coil. It should however be noted that the listed advantageous design options for the coil arrangement are only to be interpreted in an exemplary fashion.

The coil arrangement can furthermore comprise at least one coil which has outer windings in a first winding direction and inner windings in a second winding direction that is oriented oppositely to the first winding direction. This too ensures the advantages described above.

The advantages specified above are also ensured in an electrical apparatus which is designed for inductive energy transmission to a further electrical apparatus and comprises a corresponding monitoring apparatus.

The electrical apparatus can be a charging station, a mobile device, an electric bicycle, an electric or hybrid vehicle, a three wheeler, a pedelec, a wheel chair, a mobile telephone, a portable computer and/or battery charging electronics. The present invention also thus facilitates a charging of batteries for a multiplicity of application options.

The method for monitoring at least a partial surrounding area of at least one electrical apparatus designed for inductive energy transmission also implements the corresponding advantages. The method can be modified according to the design options for the monitoring apparatus that are described above.

In addition, the advantages described can also be implemented by carrying out the corresponding method for inductive energy transmission between two electrical apparatuses.

### BRIEF DESCRIPTION OF THE DRAWINGS

Further features and advantages of the present invention are explained below with the aid of the drawings. In the drawings:

FIGS. 1a to 1c show schematic depictions of a first embodiment of the monitoring apparatus;

FIGS. 2a to 2c show schematic depictions of a second embodiment of the monitoring apparatus;

FIG. 3 shows a schematic partial depiction of a third embodiment of the monitoring apparatus;

FIG. 4 shows a schematic partial depiction of a fourth embodiment of the monitoring apparatus;

FIGS. 5a and 5b show schematic depictions of a fifth embodiment of the monitoring apparatus;

FIG. 6 shows a schematic partial depiction of a sixth embodiment of the monitoring apparatus;

FIG. 7 shows a schematic partial depiction of a seventh embodiment of the monitoring apparatus;

FIG. 8 shows a schematic partial depiction of an eighth embodiment of the monitoring apparatus;

FIG. 9 shows a schematic depiction of a ninth embodiment of the monitoring apparatus;

FIG. 10 shows a schematic partial depiction of a tenth embodiment of the monitoring apparatus;

FIG. 11 shows a schematic partial depiction of an eleventh embodiment of the monitoring apparatus;

FIG. 12 shows a schematic partial depiction of a twelfth embodiment of the monitoring apparatus;

FIG. 13 shows a schematic partial depiction of a thirteenth embodiment of the monitoring apparatus; and

FIG. 14 shows a flow diagram for explaining an embodiment of the method for monitoring at least one partial surrounding area of at least one electrical device designed for inductive energy transmission.

### DETAILED DESCRIPTION

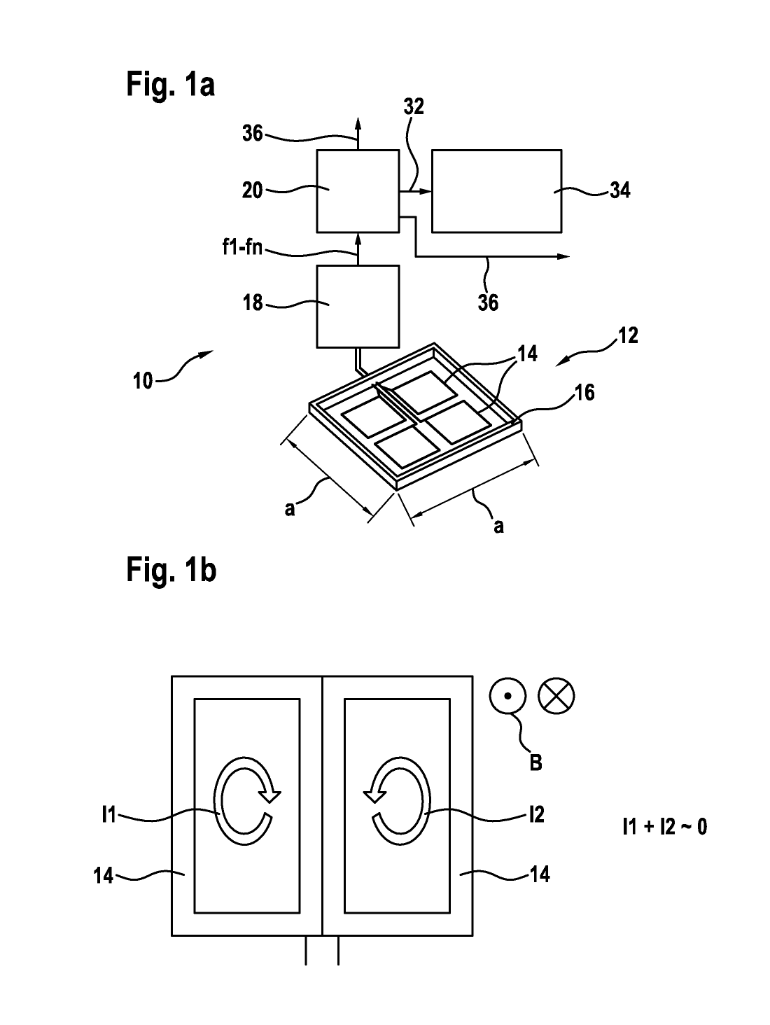

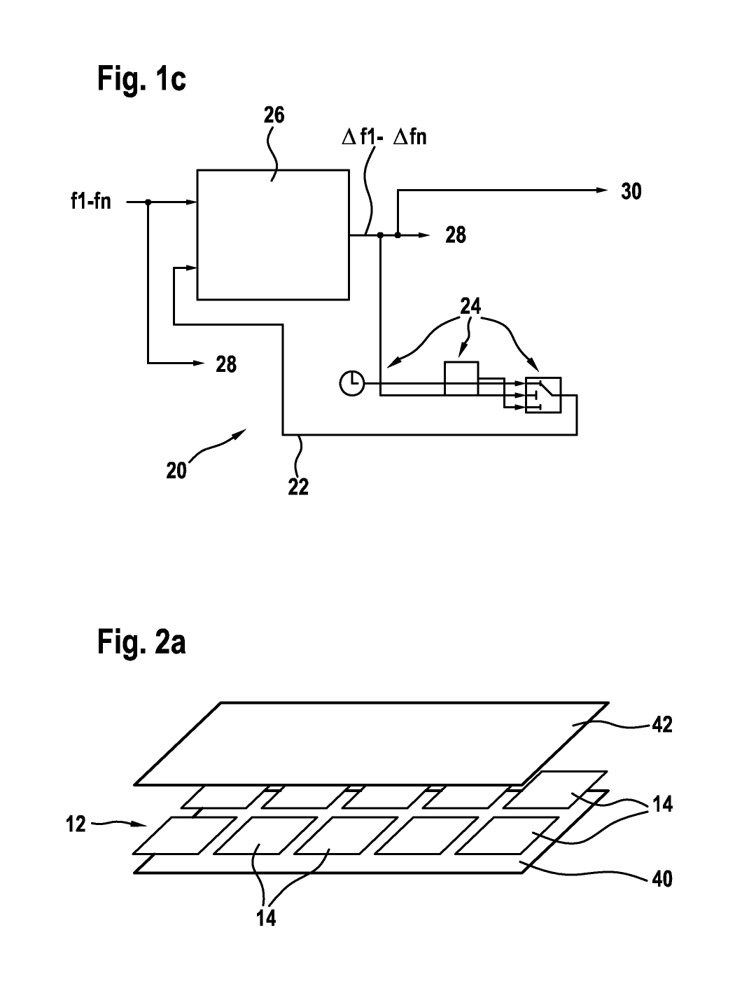

FIGS. 1a to 1c show schematic depictions of a first embodiment of the monitoring apparatus.

The monitoring apparatus 10 schematically depicted in FIG. 1a is designed for monitoring at least one partial surrounding area of at least one electrical apparatus designed for inductive energy transmission for the purpose of identifying at least one undesired foreign object which possibly lies within said partial surrounding area. The electrical apparatus can refer to any apparatus which is equipped with at least one induction device (coil) and which is designed for inductive energy transmission to a further electrical apparatus. Such an electrical apparatus can, for example, be a (stationary or mobile) charging station, a mobile device, an electric bicycle (electric bike, E-bike), an electric or hybrid vehicle, a (motorized) three wheeler, a pedelec, a (motorized) wheel chair, a mobile telephone, a portable computer and/or battery charging electronics, in particular vehicle battery charging electronics. The further electrical apparatus, which is likewise preferably equipped with at least one induction apparatus (coil) for inductive energy transmission, can be one of the apparatuses listed here. The aforementioned examples do not however limit the usability of the monitoring apparatus 10.

In order to monitor at least the partial surrounding area of the electrical apparatus, the monitoring apparatus 10 comprises a sensor device 12 with a coil arrangement comprising at least one coil 14, wherein the coil arrangement comprising the at least one coil 14 can be disposed or is disposed at, on and/or in the electrical apparatus. The coil arrangement comprising the at least coil 14 can, for example, also be integrated into the electrical apparatus. It should be noted that the monitoring apparatus 10 can however also be designed as a discrete component, which only if need be is disposed at and/or on the electrical apparatus. The at least one coil 14 of the coil arrangement can, e.g., be disposed in a coil housing 16, which can be or is disposed on a surface of the electrical apparatus. In the embodiment of FIG. 1a, the coil arrangement is configured from the at least one coil 14 on a surface which has dimensions a of approximately 300 mm. It should however be noted that the coil arrangement comprising the at least one coil 14 can even be configured smaller. A dimension a of the coil arrangement comprising the at least one coil 14 can be relatively freely selected particularly with regard to the partial surrounding area of the electrical apparatus to be monitored. The single coil 14 or at least one of the coils 14 of the coil arrangement is integrated into the at least one electronic circuit 18. In the embodiment of FIGS. 1a to 1c, the at least one electronic circuit 18 comprises at least one resonant circuit 18 which can be set into resonance and into which the at least one coil 14 of the coil arrangement is integrated. In addition, the at least one coil 14 of the coil arrangement is wound, designed and/or attached to the at least one filter in such a manner that currents and/or voltages induced (by a temporally variable magnetic field B) in the at least one coil 14 of the coil arrangement can be at least partially averaged and/or filtered out.

FIG. 1b shows by way of example a partial view of the coil arrangement comprising the at least one coil 14. It can be seen that the coil arrangement in the embodiment of FIGS. 1a to 1c comprises a plurality of coils 14 having varied winding directions. Two adjacent coils can particularly have different winding directions, so that a first induction current I1 induced in the first coil 14 of the two adjacent coils 14 by an external temporally variable magnetic field B and a second induction current I2 induced in the second coil 14 of the two adjacent coils 14 by the temporally variable magnetic field B cancel each other out. The two coils 14 depicted in FIG. 1b can thus also be described as two mutually wound half coils, the induction currents 11 and 12 of which that are induced by the temporally variable magnetic field B (virtually) cancel each other out. This can also be described in terms of the coil geometry of the coil arrangement being suitable for eliminating the induced currents of external homogenous alternating magnetic fields. If the coils were configured as typical air coils (in a ring or rectangular shape) having the same winding directions, a relatively high voltage would, in contrast, be induced in the at least one resonant circuit 18 when the temporally variable magnetic field B is present. This would lead to the resonant circuit 18 no longer oscillating at the resonance frequency thereof but at a coupled-in frequency of the temporally variable magnetic field B. This disadvantage is however rectified by means of the advantageous design of the monitoring apparatus 10.

Thus, the (external) temporally variable magnetic field B cannot exert any negative influences on the measurements for detecting at least one foreign object, said measurements being carried out by means of the coils 14. This advantage is also ensured in the case of a temporally variable magnetic field B generated for an inductive energy transmission. The advantageous coil geometry of the coil arrangement comprising the at least one coil 14 allows for the use of the at least one resonant circuit 18 for detecting at least one foreign object even when a comparatively strong temporally variable magnetic field B is present. It is therefore not necessary to interrupt an inductive energy transmission, which is carried out between the electrical apparatus and the further electrical apparatus, for examining at least the partial surrounding area for a foreign object possibly present therein. The conventional necessity for interrupting the inductive energy transmission in order to carry out a monitoring for a foreign object is therefore eliminated. A use of the monitoring apparatus 10 thus facilitates a quicker execution of the inductive energy transmission. As is furthermore explained below, the foreign object monitoring can nevertheless still be reliably carried out and with a low error rate during use of the monitoring apparatus 10.

It should furthermore be noted that the implementation of the coil arrangement comprising a plurality of coils 14 having different winding directions, which is depicted in FIG. 1b, is only to be interpreted in an exemplary fashion. The advantage of a usability of the coil arrangement, which is not influenced by the external temporally variable magnetic field B, for determining a possibly present foreign object is, e.g., also ensured if the coil arrangement comprises at least one bifilar coil, at least one figure-of-eight shaped coil, at least one butterfly coil and/or at least one binocular coil.

The monitoring apparatus 10 also comprises an evaluation device 20. The evaluation device is designed to detect whether at least one physical variable Δf1 to Δfn, which is measured by means of the at least one electronic circuit 18 or appears in the at least one electronic circuit 18, differs from at least one predefined normal range of values. In the embodiment described here, the evaluation device 20 is designed to also determine the at least one physical variable Δf1 to Δfn of the at least one resonant circuit 18. This is schematically depicted in FIG. 1c.

In the embodiment of FIG. 1c, the at least one physical variable Δf1 to Δfn can be determined by means of the evaluation device 20 as a temporal change in at least one resonance frequency f1 to fn of the at least one resonant circuit 18. To this end, the at least one resonance frequency f1 to fn of the at least one resonant circuit 18 is, for example, supplied together with a clock signal 22 to a time measuring circuit 24 of a computing unit 26. In this way, at least one temporal derivative Δf1 to Δfn of the at least one resonance frequency f1 to fn of the at least one resonant circuit 18 can particularly be reliably determined as the at least one physical variable Δf1 to Δfn. The at least one frequency f1 to fn and/or the at least one physical variable Δf1 to Δfn can also optionally be further transmitted to a storage unit 28 and/or a display device 30.

The implementation of the evaluation device 20, which is schematically depicted in FIG. 1c is however only to be interpreted in an exemplary fashion. Instead of or in addition to the temporal change in the at least one resonance frequency f1 to fn, a temporal change in the at least one resonance amplitude of the at least one resonant circuit 18 and/or a temporal change in the at least one temporally averaged amplitude of the at least one resonant circuit 18 can, for example, also be determined as the at least one physical variable Δf1 to Δfn by means of the evaluation device 20. These values too can be advantageously evaluated by the evaluation device 20 in the manner described below.

The evaluation device 20 is, e.g., designed to ascertain whether the at least one determined physical variable Δf1 to Δfn differs from the at least one predefined normal range of values by the at least one physical variable Δf1 to Δfn being compared to at least one predetermined threshold value. If the at least one predefined threshold value has been exceeded by the at least one physical variable Δf1 to Δfn, this is generally a reliable indication of the presence of at least one foreign object in a spatial surrounding area of the at least one coil 14 of the coil arrangement. This effect is also frequently assured provided that another physical variable Δf1 to Δfn is evaluated by the evaluation device 20 instead of a gradient analysis of the at least one frequency f1 to fn of the at least one resonant circuit 18.

In the event of a (at least partially metallic and/or conductive) foreign object being present in the proximity of the at least one coil 14, eddy currents are induced in the at least one foreign object, which impair the oscillatory behavior of the at least one resonant circuit 18 that was set into resonance. Thus, the presence of the at least one undesirable foreign object can be detected by means of a comparison of the at least one physical variable Δf1 to Δfn which can be simply carried out. In so doing, a triggering of the metallic parts of the vehicle chassis is not of concern.

In the embodiment of FIGS. 1a to 1c, the evaluation device 20 is designed to output at least one foreign object information signal 32 to the at least one information output electronics 34 provided that the at least one determined physical variable Δf1 to Δfn differs from the at least one predefined normal range of values. The at least one information output electronics 34 can be actuated by means of the at least one foreign object information signal 32 for outputting at least one foreign object warning signal. The at least one information output electronics 34 can, e.g., be a warning light, an image display apparatus and/or a sound output apparatus. A luminous signal, a blinking signal, a warning light, a warning image or an acoustic warning signal can, for example, be outputted as the at least one foreign object warning signal. The at least one information output electronics 34 can be integrated into the electrical apparatus and/or into the further electrical apparatus, which is designed for an inductive energy transmission to the electrical apparatus. Information output electronics 34 present as a discrete component separate from the electrical apparatuses can however also be actuated by means of the at least one foreign object information signal 32. A user can thus be made aware of the presence of the at least one foreign object before or during an inductive energy transmission.

As an alternative or in addition to the output of the foreign object information signal 32, the evaluation device 20 can also be designed to output at least one control signal 36 to the electrical apparatus and/or further electrical apparatus designed for inductive energy transmission (to the electrical apparatus). In this case, the electrical apparatus and/or the further electrical apparatus can be directed by means of the at least one control signal 36 into a predefined foreign object protection mode at least for a predefined period of time. When the electrical apparatus and/or the further electrical apparatus are located in the predefined foreign object protection mode, an inductive energy transmission between the electrical apparatus and the further electrical apparatus preferably cannot be started, is at least prevented for a predefined period of time, is concluded or can be carried out at least for the predefined period of time only at a reduced energy transmission rate with respect to a normal mode of the electrical apparatus and/or the further electrical apparatus. After detecting a presence of the at least one foreign object, the monitoring apparatus 10 thus prevents said foreign object from overheating or being damaged as a result of a further continued inductive energy transmission at a normal energy transmission rate (corresponding to the normal mode). The monitoring apparatus 10 therefore contributes to the improved safety of objects and persons in the surrounding area of an inductive energy transmission.

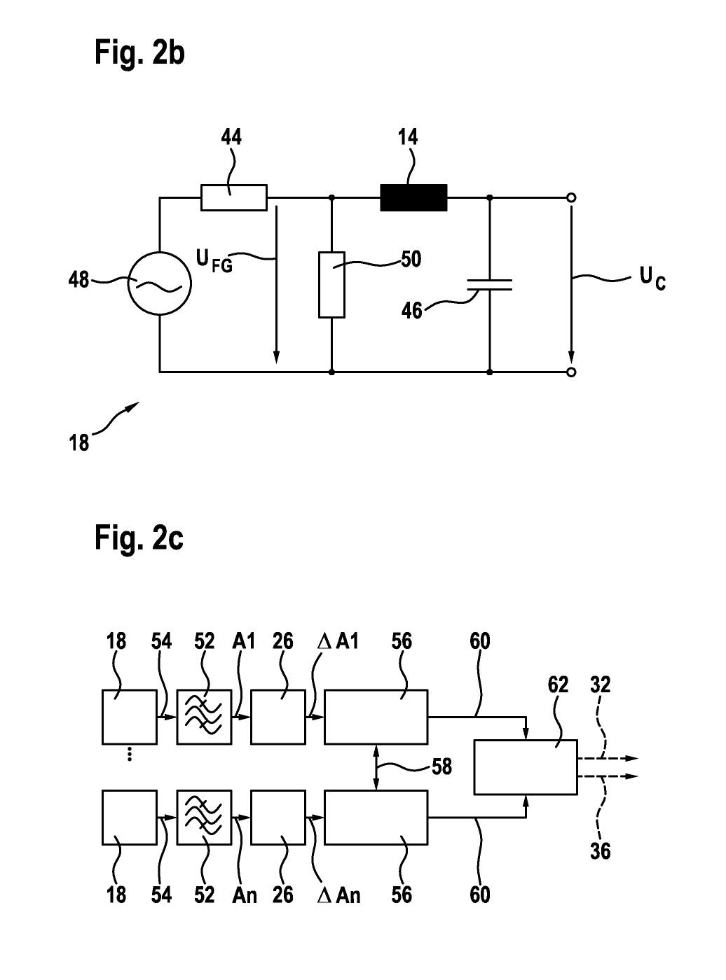

FIGS. 2a to 2c show schematic depictions of a second embodiment of the monitoring apparatus.

FIG. 2a schematically reproduces a possible mounting position of the coil arrangement 12 comprising at least one coil 14 between a primary side 40 of the electrical apparatus and a secondary side 42 of the further electrical apparatus. At least one coil/primary coil (not illustrated) can, for example, be integrated onto and/or into the primary side 40, said coil being designed for an inductive energy transmission to at least one coil/secondary coil disposed (not depicted) on and/or in the secondary side 42. In a possible embodiment, the primary side 40 is an external side of a charging station, at which a vehicle comprising the secondary side 42 designed as a vehicle underside is parked. The inductive energy transmission can be understood as an energy transmission from the electrical apparatus/charging station to the further electrical apparatus/the vehicle, e.g. for charging an energy storage unit/battery of the further electrical apparatus/the vehicle as well as an energy transmission from the further electrical apparatus/the vehicle to the electrical apparatus/the charging station. In addition, the examples for the sidesk 40 and 42 described in this section are only to be understood in an exemplary fashion. The monitoring apparatus 10 having the coil arrangement 12 comprising at least one coil can also be used to detect electrically conductive materials in at least one partial surrounding area (e.g. an interstitial gap/air gap) of a differently designed system comprising electrical apparatuses designed for inductive energy transmission.

FIG. 2b shows a circuit diagram of a resonant circuit 18, wherein each of the coils 14 of the monitoring apparatus 10 is integrated into such a discrete resonant circuit 18. The respective coil 14 is connected in series to a resistor 44. Each of the resonant circuits 18 comprises a capacitor 46 and a voltage source 48. In addition, a further resistor 50 is disposed in parallel to the capacitor 46. By means of the voltage source 48, the resonant circuit 18 can be excited with an input voltage U_{FG}. The voltage U_{C} applied in each case to the capacitor 46 can be measured.

The respective resonant circuit 18 can, for example, be excited via the resistor 44 with the input voltage U_{FG} at an amplitude of 10 volts in the resonance frequency thereof, so that a sufficiently large signal-to-noise ratio is ensured. (A superelevation of the voltage U_{C} with respect to the input voltage U_{FG} occurs in the resonance frequency.) At the same time, the voltage profile at the capacitor 46 can be continuously recorded and evaluated.

An array can also be generated from a plurality of resonant circuits 18, said array covering a space to be monitored on at least one side. In an array, offsets, which uniformly occur across all of the coils 14 (for example due to temperature fluctuations or very low lying vehicle chassis) can be easily detected and therefore eliminated. A changing vehicle clearance leads to a systematic offset which is detected and eliminated by comparing the values of all of the array elements.

A weak coupling between adjacent coils 14 can be prevented by means of a larger distance between the coils 14. In addition, different frequencies can be applied in the case of resonant circuits 18 adjacent to coils 14 in order to further minimize a coupling.

As can be seen in FIG. 2C, each of the resonant circuits 18 is attached to at least one filter 52, by means of which the signals 54 (voltages U_{C}) of the resonant circuits 18 can be filtered. In this way, parasitic effects (couplings), which are caused by an alternating magnetic field that is present between the sides 40 and 42, can be suppressed/filtered out. For example, the at least one filter 52 has the effect that only signals 54 from a relatively narrow frequency range around the resonance frequency (e.g. with a bandwidth of 50 Hz) of the evaluation device 20 are further taken into account. In terms of software, such a filtering can, for example, be implemented by means of a bandpass filter or a hardware assembly (e.g. a notch filter).

In the example of FIG. 2c, a temporal change of at least one temporally averaged amplitude A1 to An of the at least one resonant circuit 18 is determined as the at least one physical variable ΔA1 to ΔAn. The respective temporally averaged amplitude A1 to An can, for example, be determined over a temporal averaging of 0.1 seconds. The at least one physical variable ΔA1 to ΔAn can subsequently be determined by means of the computing units 26. It should however be noted that even the other variables described above for the at least one physical variable ΔA1 to ΔAn can be measured and further evaluated by means of the monitoring apparatus 10 described here.

The respective physical variable ΔA1 to ΔAn can subsequently be compared to the at least one predefined threshold value using at least one comparison unit 56. The comparison units 56 can be designed to communicate with one another by means of a communication signal 58 for adjusting the respective threshold value. Comparison signals 60 can subsequently be outputted by means of the comparison units 56, which comparison signals can subsequently be read by a central evaluation unit 62 as to whether a current variable ΔA1 to ΔAn still lies in the at least one predefined normal range of values. Provided this is not the case, at least one of the signals 32 and 36 already described can be outputted by the central evaluation unit 54.

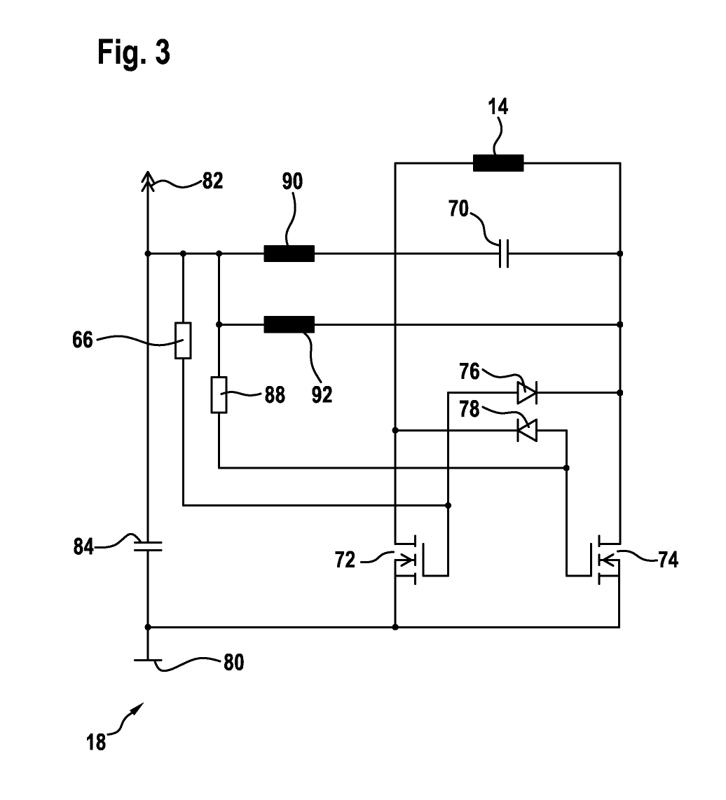

FIG. 3 shows a schematic partial depiction of a third embodiment of the monitoring apparatus.

Of the third embodiment of the monitoring apparatus 10, only a circuit diagram of the at least one resonant circuit 18 is depicted in FIG. 3. The at least one resonant circuit 18, in which the at least one coil 14 of the coil arrangement is integrated, is at least one CCFL inverter circuit. (Such a circuit can also be referred to as a Royer converter or a Royer circuit.) The use of at least one CCFL inverter circuit for the monitoring apparatus 10 has the advantage that the resonance frequency of the at least one resonant circuit 18 automatically sets itself. Such a resonant circuit 18 is thus ideal for detecting changes in the inductance thereof and load changes by means of changes in frequency.

The CCFL inverter circuit depicted schematically in FIG. 3 has a first capacitor 70 in parallel to the coil 14. A MOSFET 72 and 74 is connected electrically to each of the electrodes of said capacitor, while a gate region of the first MOSFET 72 is connected via a first diode 76 to the second electrode of the first capacitor 70. A drain region of the second MOSFET 74 on the second electrode of the first capacitor 70 and a gate region of the second MOSFET 74 are also correspondingly connected via a second diode 78 to the first electrode of the first capacitor 70. The source regions of the MOSFET 72 and 74 are connected to one another and to a ground 80. A second capacitor 84 lies between the ground 80 and a voltage source 82. Each gate region of the MOSFET 72 and 74 is furthermore connected to the voltage source 82 via respectively one resistor 86 and 88. In addition, the drain regions of the MOSFETs 72 and 74 are also connected to the voltage source 82 via respectively one coil 90 and 92. It should furthermore be noted that the CCFL inverter circuit depicted in FIG. 3 does not require a center tap of a primary coil or a control coil.

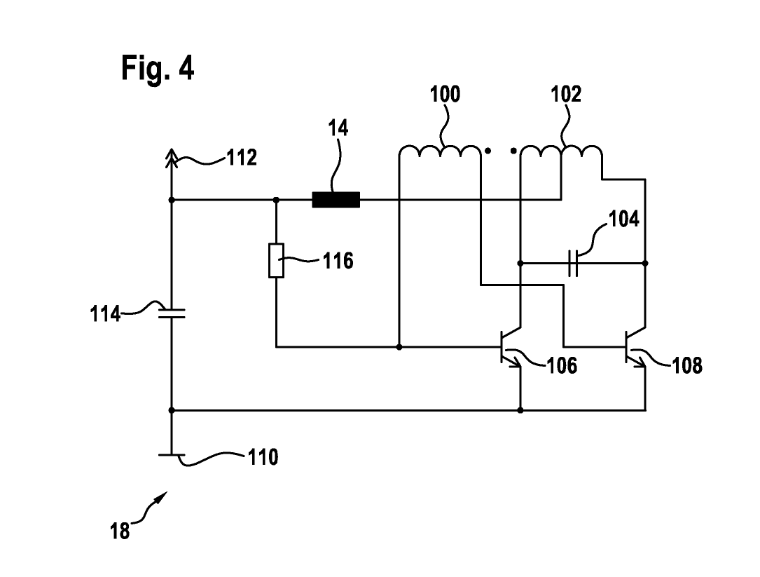

FIG. 4 shows a schematic partial depiction of a fourth embodiment of the monitoring apparatus.

The monitoring apparatus 10 partially schematically depicted in FIG. 4 also has at least one resonant circuit 18 designed as a CCFL inverter circuit. The CCFL inverter circuit is equipped with a control coil 100 and with a primary coil 102. The coil 14 is connected to the primary coil 102. In addition, a first capacitor 104 is arranged in parallel to the primary coil 102. Each of the electrodes of the first capacitor 104 is connected to respectively one collector region of a bipolar transistor 106 and 108. The base regions of the bipolar transistors 106 and 108 are in each case connected to the control coil 100. The emitter regions of the bipolar transistors 106 and 108 are connected to one another and to a ground 110. A second capacitor 114 lies between the ground 110 and a voltage source 112. The coil 14 is also connected to the voltage source 112. In addition, a base region of a bipolar transistor 106 is connected to the voltage source 112 via a resistor 116 arranged in parallel to the coil 14.

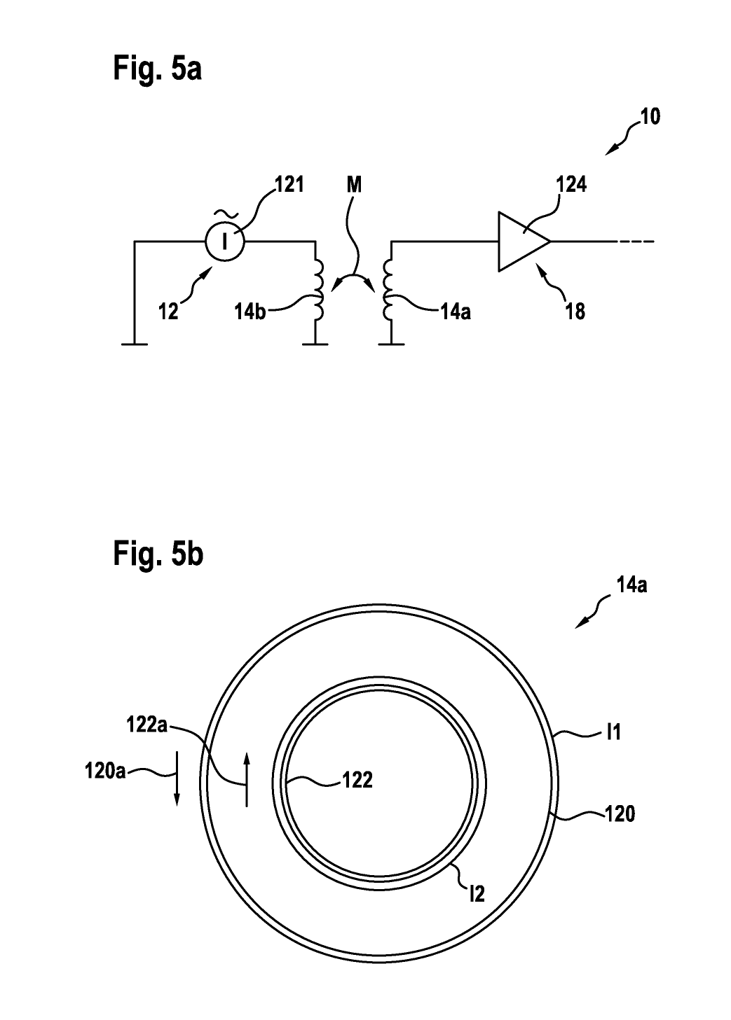

FIGS. 5a and 5b show schematic depictions of a fifth embodiment of the monitoring apparatus.

In the embodiment of FIGS. 5a and 5b, the monitoring apparatus 10 has at least one receiver coil 14a as the at least one coil 14a integrated into the at least one electronic circuit 18 and additionally at least one transmitter coil 14b. The at least one transmitter coil 14b can be operated by means of the sensor apparatus 12 in such a way that at least one electromagnetic signal can be emitted by means of the at least one transmitter coil 14b. To this end, the at least one transmitter coil 14b is, for example, connected to an AC power source 121 of the sensor apparatus 12 such that a transmission current I can be conducted through the at least one transmitter coil 14b. During the transmission of the at least one electromagnetic signal, a voltage induced in the at least one receiver coil 14a and/or an amperage generated in the at least one receiver coil 14a can be detected by means of the at least one electronic circuit 18 as the at least one physical variable. In the embodiment described here, the at least one receiver coil 14a and the at least one transmitter coil 14b are especially well decoupled so that a counter inductance M is relatively small.

The at least one receiver coil 14a of the coil arrangement, said receiver coil being depicted in FIG. 5b, has outer windings 120 having a first winding direction 120a and inner windings 122 having a second winding direction 122a oriented oppositely to the first winding direction 120a. The differing number of windings 120 and 122 is selected in relation to the unequal diameter of the windings 120 and 122 such that an (external) magnetic field homogenously permeating the respective receiver coil 14 induces a first induction current I1 in the outer windings 120 which is compensated at least partially by a second induction current 12 induced by the same magnetic field in the inner windings 122. The induction currents I1 and I2 preferably average each other out. In a surrounding area free of foreign objects of the at least one receiver coil 14a (and the at least one transmitter coil 14b), the (total) voltage or (total) amperage induced in the at least one receiver coil 14a during the transmission of the at least one electromagnetic signal is therefore (practically) averaged out. Only if a foreign object is present in the surrounding area of the at least one receiver coil 14a (and the at least one transmitter coil 14b), does a (total) voltage and/or (total) amperage unequal to zero occur in the at least one receiver coil 14a during the transmission of the at least one electromagnetic signal. The monitoring apparatus 10 of FIGS. 5a and 5b therefore produces the advantages already described above.

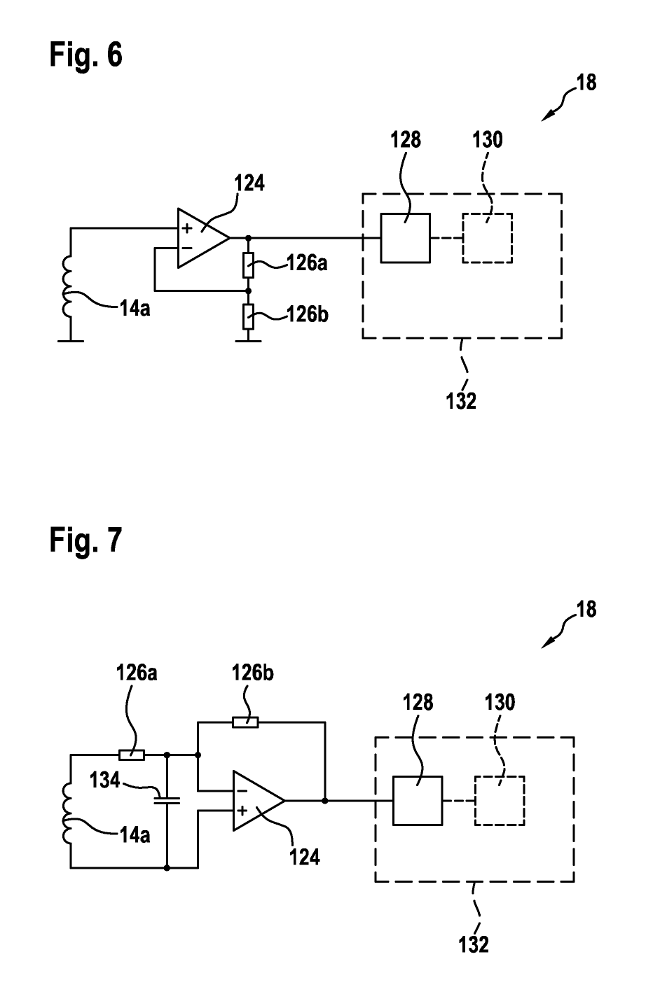

FIG. 6 shows a schematic partial depiction of a sixth embodiment of the monitoring apparatus.

In FIG. 6, an example of the at least one electronic circuit comprising the at least one integrated receiver coil 14a is depicted. (The at least one transmitter coil 14b that interacts with the at least one receiver coil 14a is not depicted.) The at least one electronic circuit 18 is designed to measure the voltage induced in the at least one receiver coil 14a (by means of the at least one electromagnetic signal). An operational amplifier 124 is configured as a non-inverting amplifier, by means of which the induced voltage can be amplified. (The amplification factor is determined by the ratio of the resistances 126a and 126b.) The operational amplifier can however alternatively be wired such that a frequency-dependent transmission function (such as, e.g., in the case of a bandpass filter) is implemented. In addition, the at least one electronic circuit 18 has at least one analog-digital converter 128, which converts the output signal of the at least one operational amplifier 124. Further software can optionally be implemented in at least one synchronous demodulator 130 connected to the at least one analog-digital converter 128. In this case, the synchronous demodulator 130 demodulates a provided signal synchronously to the alternating current of the AC power source 121 described above. The at least one analog-digital converter 128 and the at least one synchronous modulator 130 can be part of a microcontroller 132.

FIG. 7 shows a schematic partial depiction of a seventh embodiment of the monitoring apparatus.

The electronic circuit 18 schematically depicted in FIG. 7 is designed to measure the amperage induced in the at least one receiver coil 14a (by means of the at least one electromagnetic signal). An amplification factor of the operational amplifier 124 is determined from the ratio between the series resistance 126a and the further resistance 126b. A parasitic coil capacitance 134 is short-circuited in the electronic circuit 18 of FIG. 7.

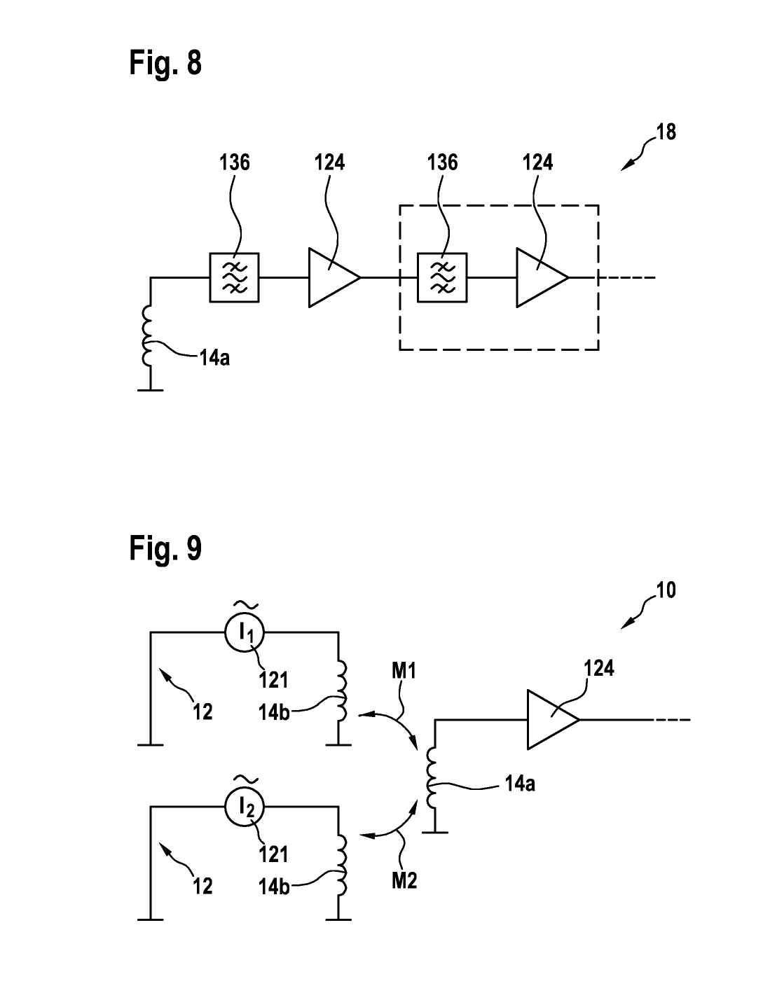

FIG. 8 shows a schematic partial depiction of an eighth embodiment of the monitoring apparatus.

As can be seen with the aid of FIG. 8, a plurality of operational amplifiers 124/amplifiers can also be connected in series in a modification to one of the electronic circuits 18 described above. The signals between the amplifier stages 136 can optionally be filtered. To this end, bandpass filters can, for example, be used.

FIG. 9 shows a schematic depiction of a ninth embodiment of the monitoring apparatus.

The embodiment of FIG. 9 has two transmitter coils 14b, of which each has a virtually vanishing magnetic coupling M1 or M2 to the single receiver coil 14a of the monitoring apparatus 10. A first transmitter coil 14b is connected to a first AC power source 121 of the sensor device 12 by means of a predefinable first transmission current I1, while a second transmission current 12 can be provided at the second transmitter coil 14b by linking said second transmitter coil to a second AC power source 121 of the sensor device 12. Provided that the signs of the magnetic couplings M1 and M2 are different, the amperage/voltage induced in the receiver coil 14a can be predefined arbitrarily small according to amount as well as according to sign by means of an independent selection of the amplitudes of the transmission currents I1 and I2. The transmission currents I1 and I2 typically have the same signal shape and the same frequency. In addition, a phase shift between the transmission currents I1 and I2 can be used to additionally reduce the amperage/voltage induced in the receiver coil 14a. It should be noted that the number of transmitter coils 14b of a monitoring apparatus can be further increased.

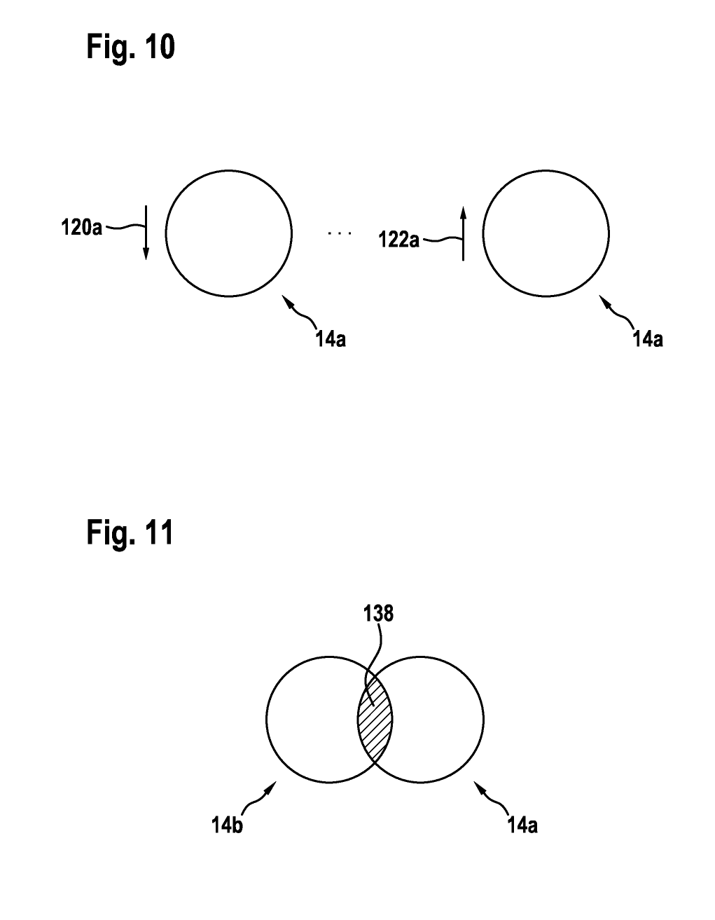

FIG. 10 shows a schematic partial depiction of a tenth embodiment of the monitoring apparatus.

The embodiment of FIG. 10 has two receiver coils 14a, wherein windings of a first receiver coil 14a of the two receiver coils 14a run in the first winding direction 120a and windings of a second receiver coil 14a of the two receiver coils 14a run in the second winding direction 122a oriented oppositely to the first winding direction 120a. The two receiver coils 14a preferably have the same number of windings, the same outside diameter and the same inside diameter. The voltages induced in the two receiver coils by an external magnetic field which homogenously permeates the two receiver coils 14a (e.g. the energy transmitting magnetic field generated by the charging device) then cancel each other out. In addition, a sum of (virtually) zero for the voltages/amperages induced in the two receiver coils 14a also results in a surrounding area of the receiver coils 14a (and the at least one transmitter coil 14b) free of foreign objects during the transmission of the at least one electromagnetic signal by a transmitter coil 14b (see, e.g. the exemplary embodiment described in FIG. 13) suitably arranged with respect to the two receiver coils 14a. A foreign object present in the surrounding area of the two receiver coils 14a (and the at least one transmitter coil 14b) during the transmission of the at least one electromagnetic signal can therefore be reliably detected by a suddenly determined increase in the sum of the voltages/amperages induced in the two receiver coils 14a. This advantage is also ensured provided that a plurality of first receiver coils 14a having the first winding direction 120a and the same number of second receiver coils 14a having the second winding direction 122a are present.

FIG. 11 shows a schematic partial depiction of an eleventh embodiment of the monitoring apparatus.

In the embodiment of FIG. 11, the at least one receiver coil 14a is disposed to partially overlap with the at least one transmitter coil 14b such that the (total) voltage or (total) amperage induced in the at least one receiver coil 14a during the transmission of the at least one electromagnetic signal disappears in a surrounding area of the at least one receiver coil 14a and the at least one transmitter coil 14b that is free of foreign objects. Only if a foreign object is present in the surrounding area of the at least one receiver coil 14a and the at least one transmitter coil 14b, does a (total) voltage and/or (total) amperage unequal to zero occur in the at least one receiver coil 14a during the transmission of the at least one electromagnetic signal. A surface area of a common overlapping surface 138 of the single (circular) receiver coil 14a and the single (circular) transmitter coil 14b of the monitoring apparatus 10 in FIG. 11 is defined to be so large that (during the transmission of the at least one electromagnetic signal by means of the at least one transmitter coil 14b) the partial currents induced in the single receiver coil 14a cancel each other out when the surrounding area is free of foreign objects. In a modification to the embodiment, the monitoring apparatus 10 can also have a plurality of transmitter and receiver coils 14a and 14b that overlap in this manner.

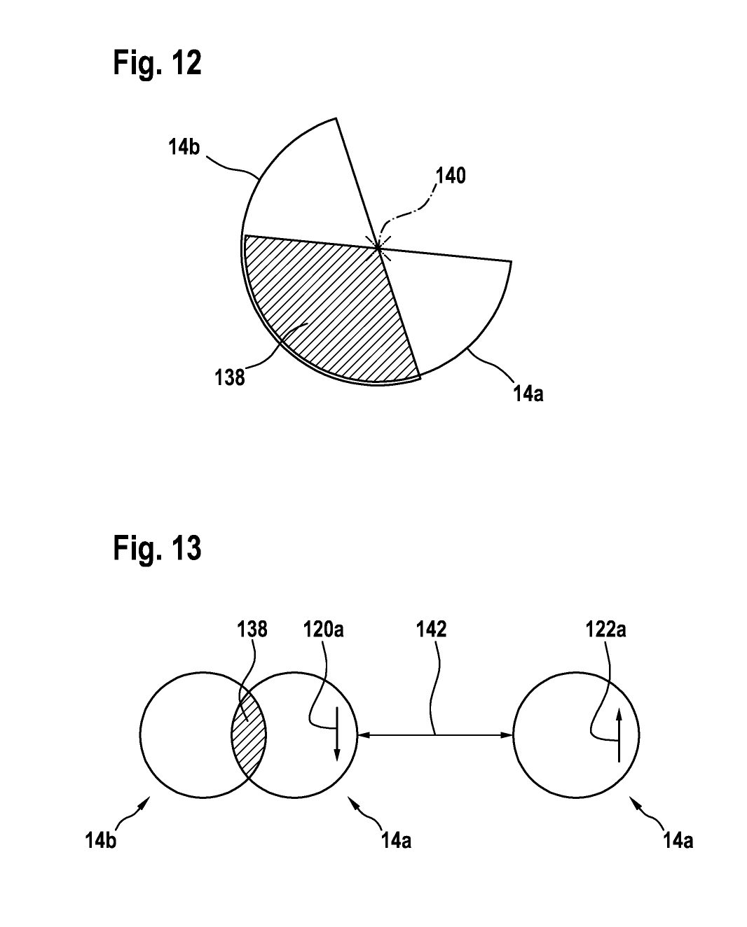

FIG. 12 shows a schematic partial depiction of a twelfth embodiment of the monitoring apparatus.

The embodiment of FIG. 12 also has a receiver coil 14a and a transmitter coil 14b, which for the purpose of magnetic decoupling are arranged partially overlapping. The receiver coil 14a and the transmitter coil 14b are designed as D-shaped coils that are twisted against each other about a common axis 140. Due to surface area of the common overlapping surface 138 which is defined suitably large, the magnetic flux of a magnetic field generated by the transmitter coil 14b permeates the receiver coil in equal parts in the positive direction and in the negative direction. Hence, a (total) voltage and/or (total) amperage unequal to zero during the transmission of the at least one electromagnetic signal occurs in the receiver coil 14a only when a foreign object is present in the surrounding area of the receiver coil 14a and the transmitter coil 14b. A modification comprising a plurality of overlapping double D coils is also possible for the example of FIG. 12.

FIG. 13 shows a schematic partial depiction of a thirteenth embodiment of the monitoring apparatus.

The embodiment of FIG. 13 comprises two receiver coils 14a having a different winding direction 120a and 122a and a single transmitter coil 14b. A surface area of the common overlapping surface 138 of a first of the two receiver coils 14a and the transmitter coil 14b and a distance between the two receiver coils 14a are defined in such a way that a magnetic decoupling between the two receiver coils 14a and the transmitter coil 14b is present. This is ensured provided that a magnetic (residual) coupling between the first receiver coil 14a and the transmitter coil 14b compensates for a (relatively small) magnetic coupling between the second receiver coil 14a and the transmitter coil 14b.

All of the monitoring apparatuses 10 described above can be used in an air gap of inductive charging systems. Even in the case of an inductive transmission of comparatively large energies by means of relatively strong electromagnetic alternating fields, the monitoring apparatuses 10 can still carry out the detection of foreign objects without interrupting the inductive energy transmission (at least for a short period of time) in order to accomplish this end. At the same time, it is ensured by means of the advantageous controllability of the inductive charging systems by the monitoring apparatuses after the detection of at least one foreign object that the eddy currents induced by the alternating fields do not lead to the at least one foreign object being heated up. Instead, the inductive charging system can be actuated in a timely fashion such that undesired heating of or damage to the at least one foreign object by the conductive materials is reliably prevented. A fire or combustions due to a foreign object becoming too hot is thus reliably prevented.

In the case of all of the monitoring apparatuses 10 described above, the influence of magnetic interference fields is not critical. The monitoring apparatuses 10 can furthermore reliably carry out the detection of foreign objects without changes to a width of an interstitial gap, for example due to a changing vehicle height or an offset of the coils 14 and 14a, distorting the measurement result. In addition, all of the monitoring apparatuses 10 ensure a sufficient robustness so that ambient conditions do not contribute to a distortion of the measurement results. A one-time calibration (due to permanently present metal in at least one coil used to inductively transmit energy) is at most necessary prior to a use of the monitoring apparatuses 10.

In a modification to the monitoring apparatuses 10, said apparatuses can additionally be equipped with at least one temperature sensor. A temperature determined by means of the at least one temperature sensor can, for example, be used for selecting the at least one threshold value or for carrying out a comparison (using a characteristic diagram of values deposited for the at least one physical variable).

The advantages of the monitoring apparatuses 10 described above are also ensured for an electrical apparatus which is equipped with the same and which is designed for inductive energy transmission to a further electrical apparatus.

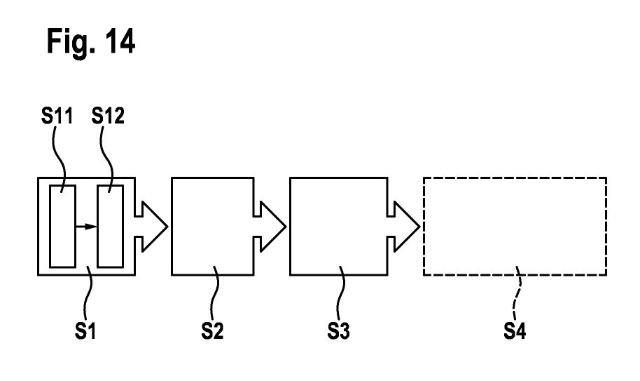

FIG. 14 shows a flow diagram for explaining an embodiment of the method for monitoring at least one partial surrounding area of at least one electrical apparatus designed for inductive energy transmission.

The method subsequently described can, for example, be carried out by means of one of the monitoring apparatuses described above. It should however be noted that the feasibility of the method is not limited to the use of such a monitoring apparatus.

In a step S1 of the method, at least one physical variable, which is measured using at least one electronic circuit or appears in the at least one electronic circuit, is determined, wherein at least one coil of a coil arrangement is connected to the respective at least one electronic circuit. The determination of the at least one physical variable takes place while the coil arrangement comprising the at least one coil is disposed at, on and/or in the electrical apparatus. It should be pointed out that the at least one coil of the coil arrangement is wound/designed and/or attached to at least one filter in such a manner that currents and/or voltages induced in the at least one coil of the coil arrangement can be at least partially averaged and or filtered out.

In step S1 of the method, at least one resonant circuit of the at least one electronic circuit, in which the at least one coil is integrated, is, for example, set into resonance while the at least one physical variable is determined. In this case, the step S1 of the method preferably comprises the sub-steps S11 and S12. In the sub-step S11, at least one frequency of the at least one resonant circuit can, e.g., be determined. In the sub-step S12, a temporal derivative of the at least one determined frequency can subsequently be formed as the at least one physical variable.

In a further advantageous embodiment, at least one electromagnetic signal is transmitted by means of at least one further coil designed as a transmitter coil while the at least one physical variable is being determined. In this case, a voltage or amperage induced in the at least one attached coil (designed as a receiver coil) is measured using the at least one electronic circuit. The at least one receiver coil can be designed in such a manner that a magnetic field homogenously permeating the at least one receiver coil induces (virtually) no voltage and/or (virtually) no current in the at least one receiver coil. The at least one receiver coil can also be alternatively integrated into the at least one electronic circuit such that induced voltages/currents are filtered out. In order to carry out the step Si of the method, means for the synchronous demodulation of the voltages/currents (comprising the alternating currents that actuate the at least one transmitter coil) that are detected in the at least one receiver coil are used in this case. The at least one demodulated signal obtained in this way can be evaluated with respect to the amplitude thereof as well as with respect to the phase thereof (relative to the respective alternating current). (The presence of a foreign object can be inferred from the amplitude of the at least one signal. The phase can be evaluated with respect to certain properties of the foreign object, such as, for example, the conductivity thereof and/or the magnetic permeability thereof—ferromagnetic or paramagnetic. The embodiment described here thus also implements a high level of sensitivity of an inductive metal detection device.)

In a step S2 of the method, it is determined whether the at least one physical variable differs from at least one predefined normal range of values. This can take place, for example, by means of a threshold value comparison. Provided the at least one determined physical variable differs from the at least one predefined normal range of values, a step S3 of the method is carried out.

In step S3 of the method, the electrical apparatus and/or a further electrical apparatus designed for the inductive energy transmission (to the former electrical apparatus) are/is controlled in a predefined foreign object control mode at least for a predefined period of time and/or at least one information output electronics for outputting at least one foreign object warning signal is actuated. Reference is made to the embodiments mentioned above regarding the foreign object protection mode and the at least one controllable information output electronics. Hence, the method schematically depicted in FIG. 14 also ensures the advantages described above.

The at least one ascertained physical variable can also optionally be stored in step S3 of the method. In this case, the at least one stored physical variable can be used as a comparative value when resuming the detection of foreign objects after at least one foreign object has been removed.

The method carried out above can also be carried out to improve a safety standard of an inductive energy transmission between two electrical apparatuses. The examination, which can be executed using the method, of at least the partial surrounding area of at least one of the two electrical apparatuses for a foreign object present therein or in close proximity thereto can take place prior to the start of the inductive energy transmission, during the resumed inductive energy transmission and/or during a (short-term) interruption of the inductive energy transmission. It should however be noted that an interruption of the inductive energy transmission is not necessary for carrying out the method described here.

1. A monitoring apparatus (10) for at least one electrical apparatus designed for inductive energy transmission, the monitoring apparatus comprising:
a sensor device (12) with a coil arrangement comprising at least one coil (14, 14a), wherein the coil arrangement including the at least one coil (14, 14a) is configured to be disposed at, on and/or in the electrical apparatus, and the single coil (14, 14a) or at least one of the coils (14, 14a) of the coil arrangement is integrated into at least one electronic circuit (18); and
an evaluation device (20), which is designed to perform one or more of the following acts:
to detect whether at least one physical variable (Δf1 to Δfn, ΔA1 to ΔAn), which is measured by means of the at least one electronic circuit (18) or appears in the at least one electronic circuit, differs from at least one predefined normal range of values, and, provided that the at least one determined physical variable (Δf1 to Δfn, ΔA1 to ΔAn) differs from the at least one predefined normal range of values,
to output at least one control signal (36) to the electrical apparatus, a further electrical apparatus designed for inductive energy transmission, or both, by means of which control signal the electrical apparatus, the further electrical apparatus, or both can be directed into a predefined foreign object protection mode at least for a predefined period of time,
to output at least one foreign object information signal (32) to at least one information output electronics (34), by means of which the at least one information output electronics (34) can be actuated to output at least one foreign object warning signal,
and wherein,
the at least one coil (14, 14a) of the coil arrangement is wound, designed, attached, or a combination of wound, designed, or attached to at least one filter (52) in such a manner that currents (I1, I2), voltages, or both induced in the at least one coil (14, 14a) of the coil arrangement can be at least partially averaged, filtered out, or both averaged and filtered out.

2. The monitoring apparatus (10) according to claim 1, wherein the at least one electronic circuit (18) comprises at least one resonant circuit (18) which can be set into resonance and into which a coil (14) of the coil arrangement is integrated.

3. The monitoring apparatus (10) according to claim 2, wherein the at least one physical variable (Δf1 to Δfn, ΔA1 to ΔAn) can be determined with respect to a temporal change in the at least one resonance frequency (f1 to fn) of the at least one resonant circuit (18), a temporal change in the at least one resonance amplitude of the at least one resonant circuit (18), a temporal change in the at least one temporally averaged amplitude (A1 to An) of the at least one resonant circuit (18), or a temporal change in any combination of the foregoing by means of the evaluation device (20).

4. The monitoring apparatus (10) according to claim 2, wherein the at least one coil (14) of the coil arrangement is integrated into the at least one CCFL inverter circuit as the at least one resonant circuit (18).

5. The monitoring apparatus (10) according to claim 1, wherein the monitoring apparatus (10) comprises at least one receiver coil (14a) as the at least one coil (14a) integrated into the at least one electronic circuit (18) and additionally at least one transmitter coil (14b), and wherein the at least one transmitter coil (14b) can be operated by means of the sensor device (12) such that at least one electromagnetic signal can be emitted by means of the at least one transmitter coil (14b) and, during the transmission of the at least one electromagnetic signal, a voltage induced in the at least one receiver coil (14a), an amperage generated in the at least one receiver coil (14a) by means of the at least one electronic circuit (18), or both can be detected as the at least one physical variable.

6. The monitoring apparatus (10) according to claim 5, wherein the at least one receiver coil (14a) is disposed to overlap with the at least one transmitter coil (14b) in such a manner that the voltage, the amperage, or both are induced in the at least one receiver coil (14a) during the transmission of the at least one electromagnetic signal is/are averaged out when the surrounding area of the at least one receiver coil (14a) and the at least one transmitter coil (14b) is free of foreign objects.

7. The monitoring apparatus (10) according to claim 1, wherein, when the electrical apparatus, the further electrical apparatus, or both are located in the predefined foreign object protection mode, an inductive energy transmission between the electrical apparatus and the further electrical apparatus cannot be started, is prevented at least for the predefined period of time, is concluded or can be carried out at least for the predefined period of time only with a reduced energy transmission rate in relation to a normal mode of the electrical apparatus, the further electrical apparatus, or both.

8. The monitoring apparatus (10) according to claim 1, wherein the coil arrangement comprises a plurality of coils (14, 14a) having varied winding directions (120a, 122a).

9. The monitoring apparatus (10) according to claim 1, wherein the coil arrangement comprises at least one bifilar coil, at least one figure-of-eight shaped coil, at least one butterfly coil, at least one binocular coil, or a combination of the same.

10. The monitoring apparatus (10) according to claim 1, wherein the coil arrangement comprises at least one coil (14a), which has outer windings (120) having a first winding direction (120a) and inner windings (122) having a second winding direction (122a) oriented oppositely to the first winding direction (120a).

11. An electrical apparatus, which is designed for inductive energy transmission to a further electrical apparatus, comprising a
monitoring apparatus (10) according to claim 1.

12. The electrical apparatus according to claim 11, wherein the electrical apparatus is at least one selected from the group comprising a charging station, a mobile device, an electric bicycle, an electric or hybrid vehicle, a three wheeler, a pedelec, a wheel chair, a mobile telephone, a portable computer, and battery charging electronics.

13. A method for monitoring at least on partial surrounding area of at least one electrical apparatus designed for inductive energy transmission, comprising the following steps:
determining at least one physical variable (Δf1 to Δfn, ΔA1 to ΔAn), wherein the at least one physical variable (Δf1 to Δfn, ΔA1 to ΔAn) is measured by means of at least one electronic circuit (18) associated with at least one coil (14, 14a) of a coil arrangement comprising at least one coil (14, 14a) that is disposed at, on, or in the electrical apparatus, wherein the at least one coil (14, 14a) cooperates with at least one filter (52) in such a manner that currents (I1, I2), voltages, or both currents and voltages induced in the at least one coil (14, 14a) of the coil arrangement are at least partially averaged, filtered out, or both averaged and filtered out (S1);
determining whether the at least one determined physical variable (Δf1 to Δfn, ΔA1 to ΔAn) differs from at least one predefined normal range of values (S2); and
provided that the at least one determined physical variable (Δf1 to Δfn, ΔA1 to ΔAn) differs from the at least one predefined normal range of values, carrying out at least one of the following steps (S3):
directing the electrical apparatus, a further electrical apparatus, or both are designed for inductive energy transmission into a predefined foreign object protection mode at least for a predetermined period of time; and
actuating at least one information output electronics (34) for outputting at least one foreign object warning signal.

14. The method according to claim 13, wherein at least one resonant circuit (18) of the at least one electronic circuit (18), into which the at least one coil (14) is integrated, is set into resonance when determining the at least one physical variable (Δf1 to Δfn, ΔA1 to ΔAn).

15. The method according to claim 13, wherein at least one electromagnetic signal is transmitted by means of at least one further coil (14b) designed as a transmitter coil (14b) when determining the at least one physical variable (Δf1 to Δfn, ΔA1 to ΔAn).

16. The method for inductive energy transmission between two electrical apparatuses comprising the following step:
examining at least one partial surrounding area of at least one of the two electrical apparatuses for a foreign object present therein or in close proximity thereto pursuant to the method according to claim 13 prior to the start of an inductive energy transmission, during the resumed inductive energy transmission, during an interruption of the inductive energy transmission, or both.
